(19) United States
(12) Patent Application Publication
(10) Pub. No.: US 2026/0369756 A1
(43) Pub. Date: Nov. 19, 2026

(54) SECONDARY BATTERY

(71) Applicant: SAMSUNG SDI CO., LTD., Yongin-si (KR)

(72) Inventors: Sang Hyup MOON, Yongin-si (KR); Keun Woo PARK, Yongin-si (KR)

(21) Appl. No.: 19/410,128

(22) Filed: Dec. 5, 2025

(30) Foreign Application Priority Data
May 14, 2025 (KR) 10-2025-0062288

(51) Int. Cl. H01M 50/145; H01M 50/107; H01M 50/134; H01M 50/152; H01M 50/159; H01M 50/164; H01M 50/516

(52) U.S. Cl. CPC H01M 50/145; H01M 50/134; H01M 50/152; H01M 50/159; H01M 50/164; H01M 50/516; H01M 50/107

(57) ABSTRACT

A secondary battery includes a case and an electrode assembly accommodated in the case. A cap assembly seals the case. The cap assembly includes a first metal member including a plurality of first groove portions and a second metal member including a plurality of second groove portions and plated on the first metal member.

### CROSS-REFERENCE TO THE RELATED APPLICATION

The present application claims priority to and the benefit of Korean Patent Application No. 10-2025-0062288, filed on May 14, 2025, in the Korean Intellectual Property Office, the entire disclosure of which is incorporated herein by reference.

### BACKGROUND

### 1. Field

The present disclosure relates to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

The present disclosure provides a secondary battery capable of preventing oxidation (e.g., rust) caused by exposure of a metal substrate (e.g., Fe) that may occur in a cap assembly and having improved weldability of a bus bar. To achieve this, groove portions are formed in a surface of a metal substrate constituting a cap assembly through a pressing process, and then a plating layer (e.g., Ni or NiP) is formed, thereby preventing metal exposure that may occur during laser etching.

In a conventional laser etching process, a metal substrate may be exposed to the atmosphere when a plating layer is removed, which then poses a risk of oxidation. To address this issue, the present disclosure provides a method in which groove portions are formed in a surface of a metal substrate through a pressing process without laser etching. Then, a plating layer is formed. This method may prevent oxidation caused by exposure of the metal substrate that would otherwise occur as the result of laser etching.

Further, the present disclosure provides a secondary battery capable of having an enhanced bonding force between a metal substrate and a plating layer through surface processing, thereby improving weldability with a bus bar and securing weld strength.

These and other aspects and features of the present disclosure will be described in or will be apparent from the following description of embodiments of the present disclosure.

According to aspects of the present disclosure, a secondary battery includes a case, an electrode assembly accommodated in the case, and a cap assembly sealing an opening in the case, wherein the cap assembly includes a first metal member including a plurality of first groove portions and a second metal member including a plurality of second groove portions and plated on the first metal member.

In one or more embodiments, the first metal member may include iron (Fe), and the second metal member may include nickel (Ni) or nickel-phosphorus (NiP).

In one or more embodiments, the plurality of first groove portions and the plurality of second groove portions may be formed to overlap each other in a thickness direction.

In one or more embodiments, the first metal member may include a first metal outer surface and a first metal inner surface opposite the first metal outer surface, and the plurality of first groove portions may be formed in the first metal outer surface.

In one or more embodiments, the second metal member may include a second metal outer surface and a second metal inner surface opposite to the second metal outer surface, and the plurality of second metal groove portions may be formed in the second metal outer surface.

In one or more embodiments, the first metal member may include a flat first metal outer surface and a first metal inner surface opposite to the first metal outer surface, and the plurality of first groove portions may be formed in the first metal outer surface. The second metal member may include at second metal outer surface and a second metal inner surface opposite to the second metal outer surface and in contact with the first metal outer surface, and the plurality of second groove portions may be formed in the second metal outer surface. The plurality of second groove portions may be provided above the plurality of first groove portions.

In one or more embodiments, the plurality of first metal groove portions and the plurality of second metal groove portions may be at least one of straight lines, straight lines intersecting each other, circles, triangles, rectangles, pentagons, hexagons, or a matrix shape.

In one or more embodiments, each of first groove portions and each of second groove portions may have a depth of 0.01 mm to 0.09 mm.

In one or more embodiments, each of first metal groove portions and each of second metal groove portions may have a width of 0.01 mm to 0.3 mm.

In one or more embodiments, the plurality of first metal groove portions or the plurality of second metal groove portions may have an area in a range from 5% to 100% of a total area of a surface of the cap assembly.

In one or more embodiments, the second metal member may have a thickness of 3 μm to 7 μm.

In one or more embodiments, the cap assembly may have a surface flatness of 0.004 mm to 0.005 mm.

In one or more embodiments, the cap assembly may have an arithmetic average roughness Ra of 1.1 μm to 1.3 μm, an average maximum height Rz of 6 μm to 9 μm, and a maximum height RzMax of 6 μm to 9 μm.

In one or more embodiments, the cap assembly may have a surface hardness of 250 HV to 310 HV.

In one or more embodiments, the secondary battery may further include a bus bar welded to the cap assembly, and the bus bar may have a weld tensile strength of 10 kgf to 21 kgf with respect to the cap assembly.

In one or more embodiments, a single bonded region is formed between the bus bar and the second metal member by resistance welding.

In one or more embodiments, a plurality of bonded regions is formed between the bus bar and the second metal member by resistance welding.

In one or more embodiments, a portion of the bus bar, a plurality of bonded regions is formed between the bus bar and the second metal member by ultrasonic welding.

According to aspects of the present disclosure, a method of manufacturing a cap assembly for a secondary battery includes providing a first metal member including a plurality of first groove portions by a pressing process and providing a second metal member on the first metal member by a plating process, the second metal member including a plurality of second groove portions overlapping the plurality of first groove portions The first metal member may include iron (Fe), and the second metal member may include nickel (Ni) or nickel-phosphorus (NiP).

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to an embodiment of the present disclosure;

FIG. 2 is a cross-sectional view taken along line 2-2 in FIG. 1;

FIG. 3 is a plan view of a cap assembly according to an embodiment of the present disclosure;

FIG. 4 is a cross-sectional view taken along line 4-4 in FIG. 3;

FIG. 5 is a cross-sectional view of a laser etching process according to a comparative example;

FIG. 6 is a plan view of a cap assembly according to another embodiment of the present disclosure;

FIG. 7 is a plan view of a cap assembly according to still another embodiment of the present disclosure;

FIG. 8 is a plan view of a cap assembly according to a further embodiment of the present disclosure;

FIG. 9 is a flowchart showing a method of manufacturing a battery pack according to another embodiment of the present disclosure;

FIG. 10 is a graph showing weld tensile strength in the comparative example and the present disclosure;

FIG. 11 is a graph showing weld strength with respect to hardness of the cap assembly in the comparative example and the present disclosure;

FIG. 12 is a cross-sectional view showing a state after performing resistance welding between the secondary battery and a bus bar according to the present disclosure;

FIG. 13 is a cross-sectional view showing a state after performing ultrasonic welding between the secondary battery and the bus bar according to the present disclosure;

FIG. 14 is a cross-sectional view showing a state after performing laser welding between the secondary battery and the bus bar according to the present disclosure;

FIGS. 15 and 16 are perspective views showing a battery pack including the exemplary cylindrical secondary battery according to the present disclosure; and

FIGS. 17 and 18 are perspective and side views showing a vehicle including an exemplary battery pack according to the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

In general, in making a cap assembly for a secondary battery, a metal plating layer (e.g., Ni) is applied to a surface of a metal substrate (e.g., Fe) to enhance corrosion resistance and weldability. However, such a conventional process has several problems. For example, before welding a bus bar to the cap assembly, a laser is used to clean the surface of the plating layer, thereby making the plating layer uniform and removing an oxide film. In general, about 2 μm to 3 μm of the plating layer is removed in this process. However, this approach may cause variation in the thickness of the plating layer. Further, if the thickness of the plating layer is approximately 4 μm, then the surface of the metal substrate may become directly exposed to the atmosphere after laser etching. This may result in oxidation (rust) of the exposed metal substrate.

For example, if the surface of the metal substrate is exposed to the atmosphere, oxidation may occur in a high-temperature and high-humidity environment. To prevent this problem, it may be necessary to increase the thickness of the plating layer or to perform a separate rust-prevention treatment. However, increasing the thickness of the plating layer tends to cause greater variation in the thickness of the plating layer, which may degrade the quality of the product. Further, increasing the thickness of the plating layer may result in extended production time and reduced productivity. Generally speaking, if the thickness of the plating layer is not uniform, thickness variation may result in non-uniform plating quality. For example, if the plating layer is excessively thick or thin, there is an increased risk of exposure of the metal substrate. This may degrade the durability and safety of the product.

Additional processes for preventing exposure of the metal substrate after laser etching have been developed. For example, attempts have been made to block exposure of the metal substrate by a performing rust-prevention treatment or increasing the thickness of the plating layer. However, such processes result in increased cost and processing time.

Hereinafter, a secondary battery according to the present disclosure for addressing the above-described problems will be described.

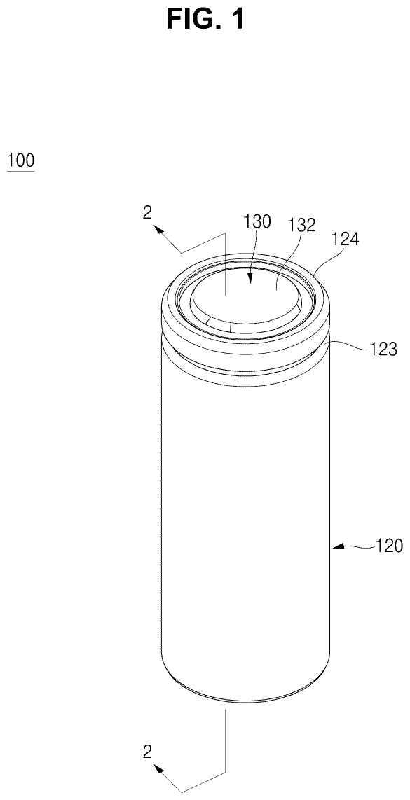

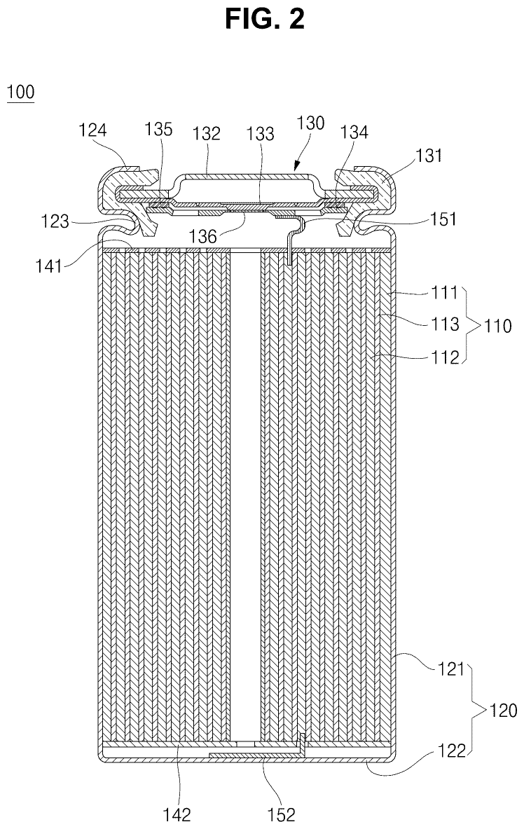

FIG. 1 is a perspective view showing a secondary battery 100 according to an embodiment of the present disclosure, and FIG. 2 is a cross-sectional view taken along line 2-2 in FIG. 1. In the example shown in FIGS. 1 and 2, the secondary battery 100 includes an electrode assembly 110, a case 120 in which the electrode assembly 110 and an electrolyte (optional) are accommodated, and a cap assembly 130 that is coupled to the case 120 to seal the case 120.

The electrode assembly 110 may include a first electrode plate 111, a second electrode plate 112, and a separator 113 disposed between the first and second electrode plates 111 and 112. The electrode assembly 110 may be provided as a cylindrical structure in which the first electrode plate 111, the second electrode plate 112, and the separator 113 disposed between the first and second electrode plates 111 and 112 are stacked and wound together. The first electrode plate 111 may include a first substrate and a first active material layer (e.g., a positive electrode active material) provided on the first substrate. A first electrode tab 151 may be formed at a first uncoated portion of the first substrate where the first active material layer is not provided. The first electrode tab 151 may extend outward and may be electrically connected to the cap assembly 130. The second electrode plate 112 may include a second substrate and a second active material layer (e.g., a negative electrode active material) provided on the second substrate. A second electrode tab 152 may be formed at a second uncoated portion of the second substrate where the second active material layer is not provided. The second electrode tab 152 may extend outward and may be electrically connected to the case 120.

The first electrode tab 151 may be electrically connected to the cap assembly 130 via a first current collector, and the second electrode tab 152 may be electrically connected to the case 120 via a second current collector. In other embodiments, the first electrode tab 151 may be electrically connected directly to the cap assembly 130 or may be electrically connected indirectly to the cap assembly 130 via a separate first current collector. In other embodiments, the second electrode tab 152 may be electrically connected directly to the case 120 or may be electrically connected indirectly to the case 120 via a separate second current collector. In this manner, a plurality of first electrode tabs 151 and a plurality of second electrode tabs 152 may be electrically connected to the first current collector and the second current collector, respectively, thereby providing a current collecting structure suitable for a large-capacity and large-diameter secondary battery. The electrode tabs may include, or be referred to as, a lead tab, a lead, a strip terminal, a strip, an uncoated portion tab, or a substrate tab. Each electrode tab may be provided singularly or in plural. For example, the current collector may include, or be referred to as, a current collecting plate, an electrode bonding plate, an electrical connection plate, a collecting plate, an electrode connection plate, or a current collecting bonding plate. Depending on the intended use or requirements of the battery, the current collector may be provided in the form of a planar type, a slit type, a wire type, a bent type, a multilayer type, a plated type, or a mechanically coupled type.

The first electrode tab 151 and the second electrode tab 152 may extend in opposite directions. The configuration in which the electrode tabs are disposed in opposite directions may be advantageous for minimizing interference between the electrode tabs and enhancing current transfer efficiency.

In one or more embodiments, the first electrode tab 151 and the second electrode tab 152 may extend in the same direction. In this configuration, the first current collector and the second current collector may also be disposed in the same direction. The first current collector may be provided in an inner central region, and the second current collector may be provided in an outer peripheral region. This configuration may allow the current collectors to be located within the same region, thereby minimizing the volume occupied by the current collectors and reducing the welding process time. As a result, the configuration may be advantageous for increasing the battery capacity and shortening the manufacturing process time.

The case 120 may accommodate the electrode assembly 110 and an electrolyte, and the case may define the external appearance of the secondary battery 100 together with the cap assembly 130. The case 120 may include a cylindrical body portion 121 and a bottom portion 122 connected to one side of the body portion 121. A beading portion 123 recessed inward may be provided at a substantially upper side of the body portion 121. A crimping portion 124 bent inward may be provided at an open end of the body portion 121.

The beading portion 123 may suppress movement of the electrode assembly 110 inside the case 120 and may facilitate seating of a gasket 131 and the cap assembly 130. The crimping portion 124 may press an edge of the cap assembly 130 via the gasket 131, thereby securely fixing the cap assembly 130. The case 120 may be formed of stainless steel (SUS), nickel-plated iron, or aluminum.

The cap assembly 130 may be fixed to an inner side of the crimping portion 124 via the gasket 131 to thereby seal the case 120. The cap assembly 130 may include an upper cap 132, a safety vent 133, a lower cap 134, an insulating member 135, and a sub-plate 136. However, the cap assembly 130 is not limited to this example and may be variously modified. In one example, the aforementioned sub-plate 136 may be omitted. In this configuration, the safety vent and/or the electrode tab may be directly connected to the lower cap rather than being connected to the sub-plate.

The upper cap 132 may be located at an uppermost position of the cap assembly 130. The upper cap 132 may include a terminal portion that convexly protrudes upward to be connected to an external circuit. At least one exhaust port for discharging gas may be located around the terminal portion. The safety vent 133 may be located below the upper cap 132. The safety vent 133 may be connected to the lower cap 134 and/or the sub-plate 136.

If gas is generated due to overcharging or abnormal operation of the secondary battery 100, the safety vent 133 may be deformed upward by pressure so as to be separated from the lower cap 134 and/or the sub-plate 136, and may rupture. The ruptured safety vent 133 may discharge the gas to outside of the secondary battery 100, thereby preventing explosion of the secondary battery 100.

The lower cap 134 may be located below the safety vent 133. The lower cap 134 may include a first opening through which a protruding portion of the safety vent 133 is exposed and a second opening through which gas may be discharged. The insulating member 135 may be located between the safety vent 133 and the lower cap 134 to electrically insulate the safety vent 133 from the lower cap 134. The sub-plate 136 may be located below the lower cap 134 and fixed to a lower surface of the lower cap 134 to cover the first opening in the lower cap 134. The protruding portion of the safety vent 133 may be fixed to the sub-plate 136. The first electrode tab 151 extending from the electrode assembly 110 may be fixed to the sub-plate and/or the lower cap. As a result, the upper cap, the safety vent, the lower cap, and the sub-plate may be electrically connected to the first electrode plate 111 of the electrode assembly 110.

The cap assembly may have various configurations other than the configurations described above. For example, a cap assembly without an upper cap (having an upper-cap-less configuration) may be implemented. In this configuration, the upper cap may be omitted, and the safety vent may be directly exposed to outside to function as an external terminal. In another example, a cap assembly without an insulating member and a lower cap may be implemented. In this configuration, the electrode tab or the current collector may be electrically connected directly to the safety vent. And the safety vent may be substantially integrally formed with the case without an insulating gasket. In this configuration, a rivet terminal may pass through and be coupled to the safety vent. The rivet terminal may be electrically insulated from the safety vent via an insulating sealing portion, and the electrode tab and/or the current collector may be electrically connected to the rivet terminal. In configurations without an upper cap, the safety vent may be coupled to the case via a curling structure or a seaming structure instead of the crimping portion/beading portion. Also, if there is no upper cap, the safety vent may be directly welded to the case. A configuration according to the present disclosure (with an upper cap including a recessed portion and a plated portion may be applied in the same way or similarly to the safety vent in a configuration without an upper cap. For example, in a configuration without an upper cap, the safety vent may include, or be referred to as, a vent plate, a cap plate, a rivet plate, a cap, or a terminal.

A first insulating plate 141 may be interposed between the electrode assembly 110 and the cap assembly 130, and a second insulating plate 142 may be interposed between the electrode assembly 110 and the bottom portion 122 of the case 120.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiaA_{1-b}X_{b}O_{2-c}D_{c}(0.90≤a≤1.8, 0≤b≤0.5, 0≤c≤0.05); LiₐMn_{2-b}X_{b}O_{4-c}D^{c}(0.90≤a≤1.8, 0≤b≤0.5, 0≤c≤0.05); LiₐNi_{1-b-c}Co_{b}X_{c}O₂₋ₐDₐ(0.90≤a≤1.8, 0≤b≤0.5, 0≤c≤0.5, 0<a<2); LiₐNi_{1-b-c}Mn_{b}X_{c}O₂₋ₐDₐ(0.90≤α≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0: 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

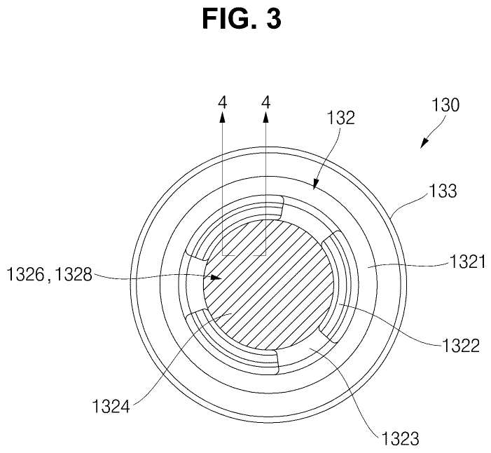

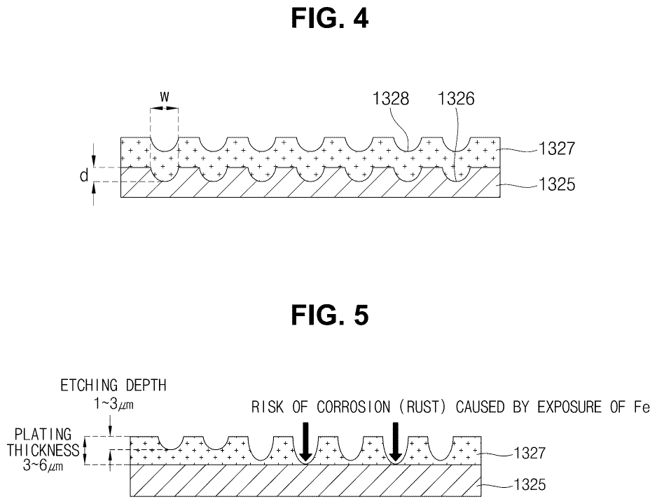

FIG. 3 is a plan view showing the cap assembly 130 according to an embodiment of the present disclosure, and FIG. 4 is a cross-sectional view taken along line 4-4 in FIG. 3. In the example shown in FIGS. 3 and 4, the cap assembly 130 include an upper cap 132 that serves as a terminal. The upper cap 132 may serve as a lid or a terminal in the secondary battery 100 and may be located at an uppermost position. The upper cap 132 may include, or be referred to as, a cap, a lid, a cover, or a terminal. The upper 132 may include an edge region 1321 to which the safety vent 133 is coupled, a bent region 1323 that is bent and extends upward from the edge region 1321 and includes a plurality of gas discharge ports 1322, and a flat region 1324 that extends from the bent region 1323 and to which a bus bar 140 is welded. As described above, in a upper-cap-less configuration, the safety vent may function as a terminal and may be referred to as an upper cap or a terminal. For example, the features of a first metal member and a second metal member, which will be described below, may be applied in the same way that the safety vent that serves as an external terminal.

In embodiments of the present disclosure, the cap assembly 130 may include two metal members, for example, a first metal member 1325 and a second metal member 1327. These two metal members may be coupled to each other through groove portions formed in the respective metal members.

The first metal member 1325 may include a plurality of first metal groove portions 1326 may be formed from a metal such as iron (Fe). The first metal member 1325 may form a basic structure of the cap assembly 130, and the second metal member 1327, which has a shape matching the shape of the first metal groove portions 1326, may be coupled to the first metal member 1325.

The second metal member 1327 may be plated on the first metal member 1325 and may include, for example, a metal such as nickel (Ni) or nickel-phosphorus (NiP). The second metal member 1327 may be plated on the first metal member 1325 to prevent corrosion and to improve weldability. A plurality of second metal groove portions 1328 may be formed in the second metal member 1327. These second metal groove portions 1328 may engage the first metal groove portions 1326 in the first metal member 1325, thereby enhancing bonding force and improving stability during welding. The groove portion may include, or be referred to as, a scratch, an uneven portion, a depressed portion, a groove, or a recess.

In embodiments of the present disclosure, a Ni plating layer may be provided using a combination of electrolytic plating and electroless plating depending on the plating method. Here, 100% Ni plating refers to plating with pure nickel to provide strong corrosion resistance and oxidation prevention. Electrolytic plating may form a plating layer using electric current and may provide excellent plating quality and uniformity. Electroless plating may proceed through a chemical reaction and may form a uniform plating layer even on complex shapes.

Ni+P plating may form a plating layer in which nickel (Ni) and phosphorus (P) are combined and may improve corrosion resistance and hardness. Ni+P plating may be mainly used in electroless plating processes and may enhance durability and wear resistance. Ni+P plating may also relieve internal stress and improve mechanical properties. For example, electroless plating may form a uniform plating layer even on components having complex shapes.

The first metal groove portions 1326 and the second metal groove portions 1328 may be formed in a plurality of straight lines that are arranged in parallel. In embodiments, the cross-sectional shapes of the first and second metal groove portions 1326 and 1328 may include a wave shape, a sawtooth shape, or a square wave shape in a horizontal direction. In other embodiments, the plurality of groove portions 1326 and 1328 may be in a shape including straight lines intersecting each other, a shape including a plurality of concentric circles, a shape including triangles arranged in a predetermined pattern, a shape including rectangles arranged in a predetermined pattern, a shape including pentagons arranged in a predetermined pattern, a shape including hexagons arranged in a predetermined pattern, or a matrix shape.

The two metal members formed in the above-described manner may be coupled to each other to form, for example, the upper cap 132. This structure may serve to improve weldability and durability. This structure may also serve to reduce surface hardness and to enhance bonding force during welding. As described above, because of the plurality of groove portions 1326 and 1328, the present disclosure may enhance the bonding force and weldability between the first metal member 1325 and the second metal member 1327, may prevent oxidation, and may improve durability.

The first metal groove portions 1326 and the second metal groove portions 1328 may overlap each other in a thickness direction. The first metal groove portions 1326 may be formed through a pressing process, which allows the two metal members to be physically coupled to each other. The first metal groove portions 1326 and the second metal groove portions 1328 that overlap each other in the thickness direction may enhance bonding force between the metal members. For example, overlapping of the groove portions 1326 and 1328 may increase bonding strength and may improve the stability of a bonded portion during welding. The enhanced bonding force may further improve weldability and may also ensure corrosion resistance and durability.

the overlapping groove portions 1326 and 1328 may increase the surface area and the bonding strength at a welded portion, thereby enhancing the bonding strength during welding. For example, during welding of the bus bar, the weld strength may be enhanced, and long-term performance such as corrosion resistance may be ensured.

The first metal member 1325 may include a flat first metal outer surface and a first metal inner surface opposite to the first metal outer surface. The plurality of first metal groove portions 1326 may be formed in the first metal member 1325, in particular, the first metal groove portions 1326 may be formed in the first metal outer surface. The plurality of first metal groove portions 1326 may be formed in the first metal outer surface through a pressing process, thereby providing mechanical bonding force to enable coupling between the first metal member 1325 and the second metal member 1327.

The second metal member 1327 may include a flat second metal outer surface and a second metal inner surface opposite to the second metal outer surface. The plurality of second metal groove portions 1328 may be formed in the second metal member 1327, in particular, the second metal groove portions 1328 may be formed in the second metal outer surface. The second metal groove portions 1328 may be formed to be engaged with the first metal groove portions 1326 in the first metal member 1325, thereby enhancing the bonding force between the two metal members.

In embodiments, the second metal groove portions 1328 may be provided above the first metal groove portions 1326. The second metal member 1327 may be disposed to physically overlap the first metal groove portions 1326 in the first metal member 1325, thereby enhancing bonding force between the two metal members. Engagement between the first metal groove portions 1326 and the second metal groove portions 1328 may improve weldability and enhance durability.

The overlapping structure of the first metal groove portions 1326 and the second metal groove portions 1328 may increase the bonding force between the metal members, allowing the two metal members to have strong adhesion through the mechanical coupling of the groove portions 1326 and 1328. The overlapping structure of the groove portions 1326 and 1328 may also increase the bonding area during welding, thereby improving weld strength and providing higher stability during processes such as welding of the bus bar. Further, the overlapping structure of the groove portions 1326 and 1328 may enhance corrosion resistance and durability and may improve surface stability of the upper cap component in the secondary battery. Moreover, the coupling structure of the first metal member 1325 and the second metal member 1327 may minimize exposure of the first metal member 1325, thereby preventing oxidation and maintaining stable performance even in a high-temperature and high-humidity environment.

The first metal groove portions 1326 and the second metal groove portions 1328 may have a depth d set in a range of about 0.01 mm to about 0.09 mm. This depth refers to a depth to which the groove portions are formed in the metal surface, and the depth may serve to increase the bonding force between the metal members. If the depth of the groove portions is too large, the metal may be excessively eroded. Such erosion may be avoided by forming the groove portions at an appropriate depth range. Adjustment of the depth may be relevant to weldability and bonding force. If the depth is too small or too large, the bonding force may be reduced. Thus, it may be advantageous for the groove portions to be formed within a depth range of approximately 0.01 mm to approximately 0.09 mm.

The first metal groove portions 1326 and the second metal groove portions 1328 may have a width w set in a range of about 0.01 mm to about 0.3 mm. This width refers to a breadth of the groove portions and may serve to increase the bonding area between the metal members, thereby enhancing bonding force and weldability. If the width is too large, the structural integrity of the metal members may be weakened. By forming the groove portions within an appropriate width range, the structural integrity may be maintained. The bonding strength during welding may be optimized by adjusting the width, thereby maintaining oxidation prevention and durability.

As described above, the bonding area during welding may be improved and the weld strength may be increased by appropriately setting the depth d and the width w of the groove portions 1326 and 1328. This may provide strong bonding in processes such as welding of the bus bar and may enhance stability during welding. Further, the groove portions 1326 and 1328 having appropriate depth and width may increase the mechanical bonding force between the first metal member 1325 and the second metal member 1327, thereby allowing the two metal members to be firmly coupled to each other. The groove portions 1326 and 1328 formed within the above-described ranges may enhance oxidation prevention and durability and may ensure stable operation even in a high-temperature and high-humidity environment.

The area ratio of the first metal groove portions 1326 and the second metal groove portions 1328 may be in a range of about 5% to about 100% relative to the total area of a surface of the cap assembly. If the area ratio is less than approximately 5%, the area of the groove portions 1326 and 1328 may be relatively small, which may make the welding process of the bus bar 140 difficult. However, if the area ratio is approximately 100%, welding of the bus bar may be achieved in any region of the lower cap 132, thereby improving work convenience.

The thickness of the second metal member 1327 may be in a range of approximately 3 μm to approximately 7 μm. As described above, the second metal member 1327 may be provided by Ni plating, and it may be advantageous to set the thickness of the second metal member 1327 in a range of about 3 μm to about 7 μm. This thickness may be suitable for to achieve the advantageous physical properties and performance of the Ni plating layer. If the thickness is too small, oxidation prevention and weldability may not be sufficiently improved. Conversely, if the thickness is too large, it may be difficult to maintain uniformity of the plating layer, and the bonding force between the metal members may be reduced.

The Ni plating layer having a thickness of about 3 μm to about 7 μm may prevent oxidation of the Fe member and may minimize oxidation-related issues even in a high-temperature and high-humidity environment. This thickness range may also enhance stability during welding and may provide appropriate weld strength. Because the second metal member 1327 maintains an appropriate thickness, the second metal member 1327 may improve weldability and may assist in achieving strong bonding in processes such as welding of the bus bar. If the thickness of the Ni plating layer is appropriately set, the durability and mechanical strength of the cap-up 132 may be enhanced. If the thickness is too large or too small, it may affect durability. Therefore, if the thickness is set in a range of about 3 μm to about 7 μm, the durability may be maximized.

By setting the plating thickness to about 3 μm to about 7 μm, it is possible to improve the efficiency of the plating process and to maintain productivity while achieving oxidation prevention and weldability. This thickness range may ensure uniform plating quality and may provide satisfactory oxidation prevention and weld strength.

FIG. 5 is a cross-sectional view of a laser etching process according to a comparative example. As shown in FIG. 5, after a second metal member 1327 (e.g., Ni) is plated on a first metal member 1325 (e.g., Fe), laser etching is performed on the surface of the second metal member 1327 for welding of a bus bar. As a result, a plurality of grooves is formed in the second metal member 1327. In this configuration, a portion of the first metal member 1325 may be exposed to the outside through the grooves due to variations in the plating thickness on the second metal member 1327 and variations in the depth of the grooves caused by the laser etching process. The portion of the first metal member 1325 exposed to the outside may be easily oxidized in an external high-temperature and high-humidity environment. As a result, the bus bar may become detached from the upper cap.

Table 1 below shows differences in thickness, flatness, and hardness of an upper cap in a comparative example and an upper cap according to the present disclosure. The thickness of the upper 132 according to the present disclosure is in the same as the thickness of the comparative example, but the flatness and the hardness in the present disclosure are different from those in the comparative example. For example, while the flatness in the comparative example is approximately 0.003 mm to approximately 0.004 mm, the flatness in the present disclosure is about 0.004 mm to about 0.005 mm. While the hardness in the comparative example is approximately 301 HV to approximately 344.6 HV, the hardness in the present disclosure is approximately 250 HV to approximately 310 HV. A case in which groove portions are not formed by a pressing process is defined as an “untreated surface,” and a case in which groove portions are formed by a pressing process is defined as “surface processed with scratches.”

TABLE 1

| | Upper Cap | | |
|---|---|---|---|
| | Thickness | Flatness | Hardness |
| Classification | (mm) | (mm) | (HV) |
| Comparative Example | 0.6 | 0.003~0.004 | 301~344.6 |
| (Untreated Surface) | | | |
| Present Disclosure | 0.6 | 0.004~0.005 | 265~305 |
| (Surface Processed | | | |
| with Scratches) | | | |

Table 2 below shows differences in arithmetic average roughness Ra (μm), average maximum height Rz (μm), and maximum height RzMax (μm) between the upper cap of the comparative example and the upper cap of the present disclosure. In Table 2,“®” represents grooves in a transverse direction, and “200” represents grooves in a longitudinal direction. As shown in Table 2, the values of Ra, Rz, and RzMax in the present disclosure are greater than those in the comparative example. For example, in the present disclosure, Ra is about 1.1 μm to about 1.3 μm, and Rz and RzMax are about 6 μm to about 9 μm.

TABLE 2

| Classification | | Ra (μm) | Rz (μm) | RzMax (μm) |
|---|---|---|---|---|
| Comparative Example | #1 | 0.726 | 4.21 | 4.47 |
| (Untreated Surface) | #2 | 0.696 | 3.973 | 5.345 |
| Present Disclosure | [symbol] → | 1.226 | 6.394 | 6.941 |
| (Surface Processed | [symbol] → | 1.282 | 8.199 | 8.908 |
| with Scratches) | | | | |

In the present disclosure, the surface processing described above results in reduction in hardness by approximately 50 HV and increase in roughness value. Because of this reduction in surface hardness and the increase in roughness value, the weld strength between the bus bar and the cap-up may be enhanced.

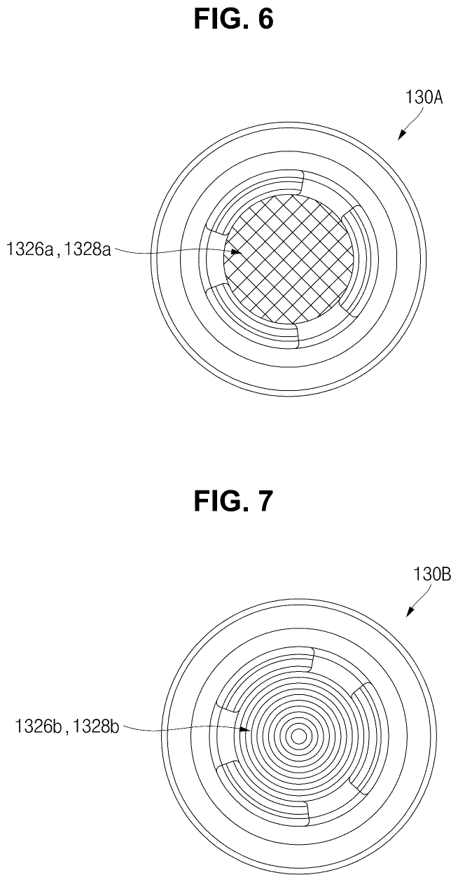

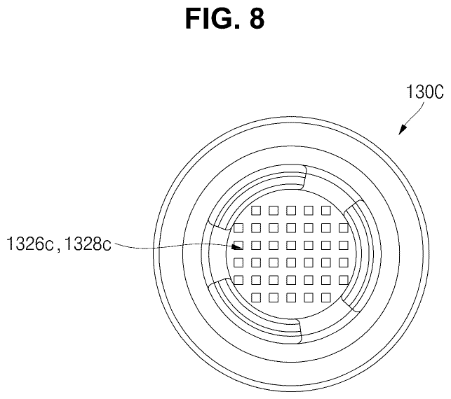

FIGS. 6, 7, and 8 are plan views showing cap assemblies 130a, 130b, and 130c according to further embodiments of the present disclosure. As shown in FIG. 6, first and second metal groove portions 1326a and 1328a may be formed in a shape including straight lines intersecting each other. As shown in FIG. 7, first and second metal groove portions 1326b and 1328b may be formed in a shape including a plurality of concentric circles. As shown in FIG. 8, first and second metal groove portions 1326c and 1328c may be formed in a matrix shape in which a plurality of rectangles is arranged.

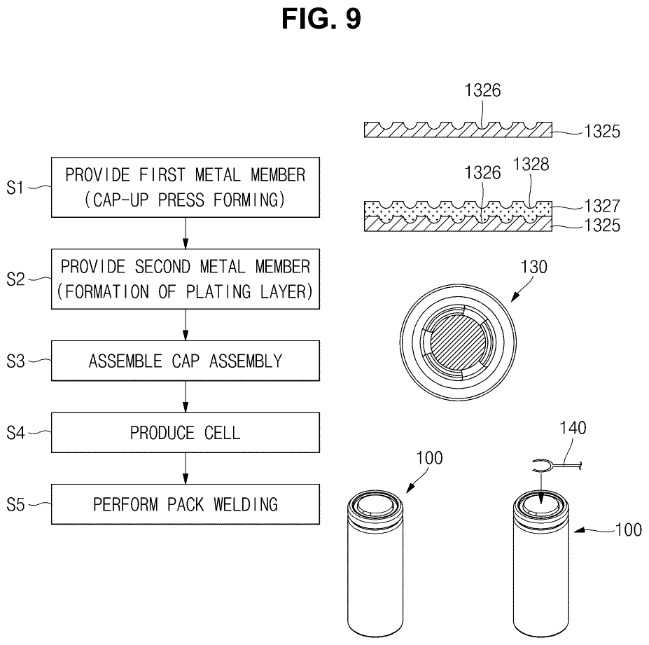

FIG. 9 is a flowchart for a method of manufacturing a battery pack according to another embodiment of the present disclosure. In the example shown in FIG. 9, the method of manufacturing a battery pack according to the present disclosure may include a first metal member providing step S1, a second metal member providing step S2, a cap assembly assembling step S3, a cell production step S4, and a pack welding step S5.

In the first metal member providing step S1, for example, a plurality of first metal groove portions 1326 may be formed in a first metal member 1325 through a pressing process. Through a pressing process, the first metal member 1325 may be manufactured in the shape of the upper cap 132, and the plurality of first metal groove portions 1326 may be formed in a flat region of the upper cap 132, which is the uppermost side of the upper cap 132. For example, through a pressing process, an edge region 1321, a bent region 1323 having gas discharge ports 1322, and a flat region 1324 that serves as a terminal may be formed, and the plurality of first metal groove portions 1326 may be formed in the flat region 1324.

In the second metal member providing step S2, for example, a second metal member 1327 having second metal groove portions 1328 may be provided on the first metal member 1325 through a plating process such that the second metal groove portions 1328 overlap the first metal groove portions 1326. The second metal member 1327 may be formed on the entire surface of the first metal member 1325, including the first metal groove portions 1326. For example, the second metal member 1327 may cover all of the edge region 1321, the bent region 1323, and the flat region 1324 of the upper cap 132.

In the cap assembly assembling step S3, a cap assembly 130 having a current interrupt device (CID) function may be assembled. The cap assembly 130 may include an upper cap 132 including the first metal member 1325 and the second metal member 1327 described above, a safety vent 133 coupled to peripheral and lower portions of the upper cap 132, a lower cap 134 attached to a lower portion of the safety vent 133 with an insulating ring 135 interposed therebetween, and a sub-plate 136 located below the lower cap 134.

In the cell production step (S4), an electrode assembly 110 may be mounted in a cylindrical case 120, an electrolyte may be injected into the cylindrical case 120, and an upper opening in the cylindrical case 120 may be sealed with the cap assembly 130 described above. A first electrode plate 111 of the electrode assembly 110 may be electrically connected to the cap assembly 130 via a first lead tab 151, and a second electrode plate 112 of the electrode assembly 110 may be electrically connected to a bottom portion 122 of the cylindrical case 120 via a second lead tab 152.

In the pack welding step S5, a plurality of cells made in the above-described manners, that is, secondary batteries 100, may be connected to each other via a bus bar 140 to complete a battery pack or a battery module. In this step, the bus bar 140 may be welded in various ways to the flat region of the upper cap 132 having the plurality of first and second metal groove portions 1326 and 1328 described above. The bus bar 140 may be electrically connected to the cap assembly 130, for example, by resistance welding, ultrasonic welding, or laser welding manner.

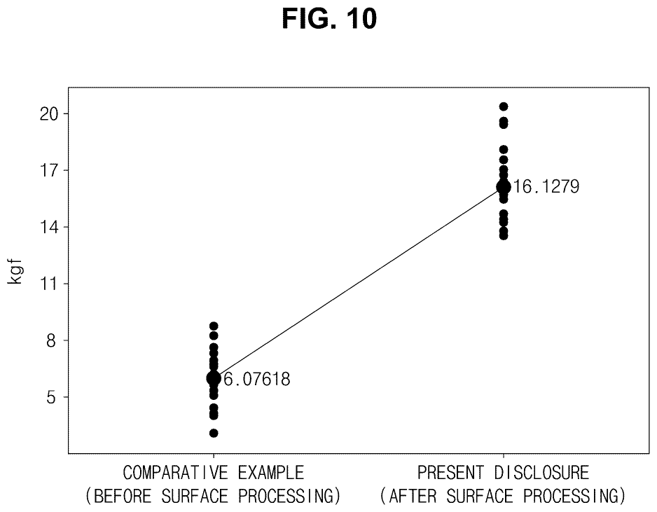

FIG. 10 is a graph showing weld tensile strength in the comparative example and in an example of the present disclosure. In FIG. 10, the X-axis represents the comparative example and the present disclosure, and the Y-axis represents weld tensile strength (kgf). As shown in FIG. 10, in the comparative example with no surface processing, the weld strength between the cap assembly 130 and the bus bar 140 is about 6.0 kgf. In contrast, in the present disclosure after surface processing, the weld strength between the cap assembly 130 and the bus bar 140 is about 16.1 kgf. Table 3 below is a comparison table showing a difference in weld strength between the comparative example and the present disclosure.

TABLE 3

| | Press Forming | |
|---|---|---|
| | Comparative Example | Present Disclosure |
| Item | (Before Surface Processing) | (After Surface Processing) |
| Avg. (kgf) | 6.08 | 16.13 |
| Min (kgf) | 3.26 | 13.52 |
| Max (kgf) | 8.30 | 20.24 |
| Standard | 1.50 | 2.10 |
| Deviation | | |

As can be seen from FIG. 10 and Table 3, after the surface processing according to the present disclosure is performed, that is, if the first metal groove portions 1326 are formed in the first metal member 1325 of the upper 132 through a pressing process and then the second metal member 1327 having the second metal groove portions 1328 is plated onto the first metal member 1325, the weld strength between the upper cap 132 and the bus bar 140 may be enhanced.

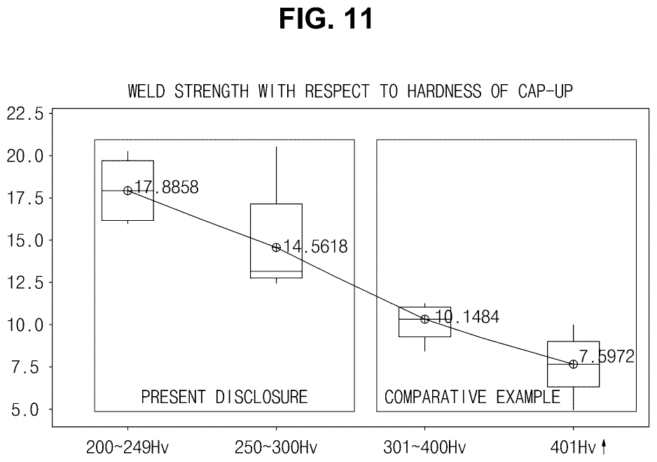

FIG. 11 is a graph showing weld strength with respect to hardness of the cap assembly 130 in a comparative example and an example of the present disclosure. In FIG. 11, the X-axis represents surface hardness (HV) in the example of the present disclosure and the comparative example, and the Y-axis represents weld tensile strength (kgf) in the example of the present disclosure and the comparative example. As shown in FIG. 11, in the comparative example with no surface processing, the surface hardness of the cap assembly 130 is about 301 HV to about 401 HV, and the weld strength between the cap assembly 130 and the bus bar 140 is about 10.1 kgf to about 7.5 kgf. As shown in FIG. 11, in the present disclosure after surface processing, the surface hardness of the cap assembly 130 is reduced to about 200 HV to about 300 HV, and the weld strength between the cap assembly 130 and the bus bar 140 is increased to about 17.8 kgf to about 14.5 kgf. Therefore, it can be seen that the cap assembly 130 according to the present disclosure exhibits reduced surface hardness and increased weld strength.

The minimum tensile strength required for welding in a battery pack may vary depending on the shape and thickness of the bus bar, but the minimum tensile strength is generally set to at least 10 kgf. This threshold serves as a reference for evaluating weld strength and bonding force, ensuring that coupling between components after welding satisfies mechanical requirements. The minimum tensile strength of 10 kgf may ensure that the bonding force between welded components is sufficiently maintained. This may be effective in ensuring that bonding between the bus bar and the upper cap component remains stable against mechanical stress. Further, the minimum tensile strength of 10 kgf may ensure that the welding quality meets the standard, thereby preventing component separation or bonding defects caused by insufficient weld strength. Further, in a battery pack welding process, the bonding strength between the bus bar and the upper cap component may be maintained at 10 kgf or more, thereby ensuring stability and durability of the welded parts. Moreover, the minimum tensile strength of 10 kgf may provide a level of strength capable of withstanding long-term use and environmental stress, thereby ensuring the safety and durability of the secondary battery.

FIGS. 12, 13, and 14 are cross-sectional views showing states after performing resistance welding, ultrasonic welding, and laser welding between the secondary battery 100 and the bus bar 140 according to the present disclosure, respectively.

As shown in FIG. 12, in the resistance welding method, a portion of the bus bar 140 and a portion of the second metal member 1327 may be melted and then cooled. During this process, a single bonded portion 150 may be formed as the melted portions cool down. Resistance welding is a method of coupling two metal members using heat generated by current, thereby providing high strength of the bonded portion 150 and strong bonding force at the single bonded portion. In this configuration, the bonded portion 150 may be formed only in the bus bar 140 and the second metal member 1327, and the bonded portion 150 may not be formed in the first metal member 1325. Because the second metal member 1327 is strongly bonded to the first metal member 1325 via the groove structure, separation may not occur between the metal members 1325 and 1327.

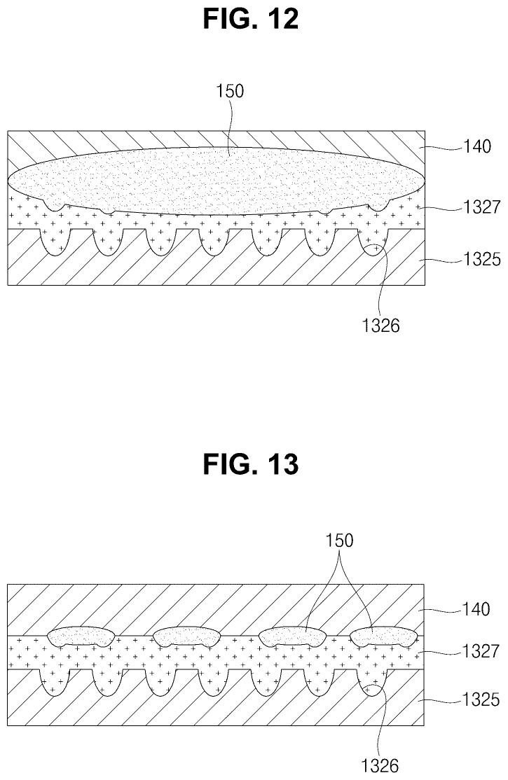

As shown in FIG. 13, in the ultrasonic welding method, a portion of the bus bar 140 and a portion of the second metal member 1327 may be melted and then cooled. During this process, a plurality of bonded portions 150 may be formed. That is, melting and cooling may occur simultaneously at multiple bonding points, resulting in formation of a plurality of bonded portions 150. In ultrasonic welding, two metal members are rapidly bonded using high-frequency vibration, thereby providing a plurality of small bonded portions and exhibiting high speed and efficiency. With this technique, the bonded portions 150 may be formed only in the bus bar 140 and the second metal member 1327 and may not be formed in the first metal member 1325. However, because the second metal member 1327 is strongly bonded to the first metal member 1325 via the groove structure, separation may not occur between the first and second metal members 1325 and 1327.

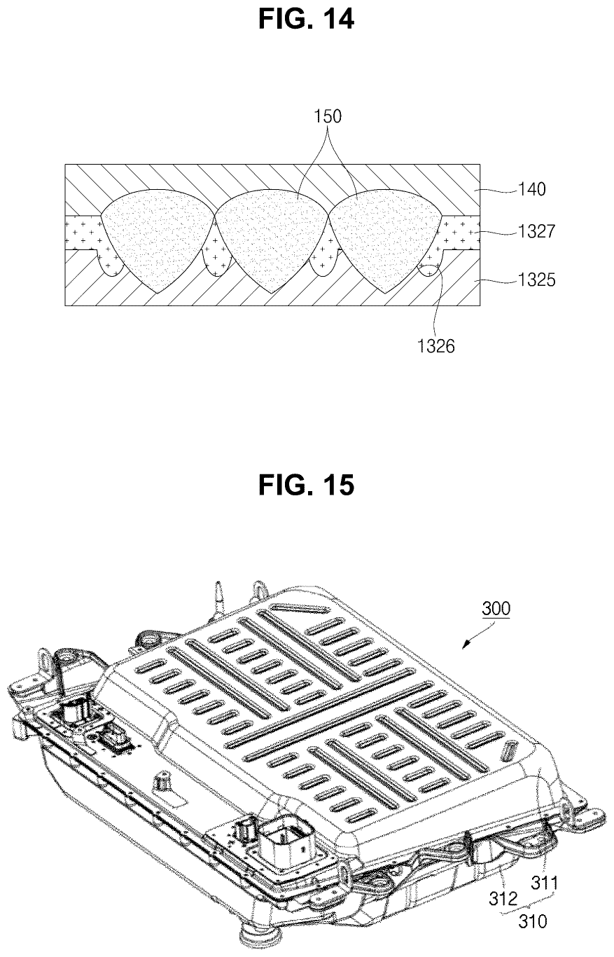

As shown in FIG. 14, in the laser welding method, a portion of the bus bar 140, a portion of the second metal member 1327, and a portion of the first metal member 1325 may be melted and then cooled. During this process, a plurality of bonded portions 150 may be formed. Here, the bus bar 140, the second metal member 1327, and the first metal member 1325 may be simultaneously melted to form multiple bonding points. Laser welding may achieve precise and high-speed bonding, and may form the plurality of bonded portions 150 with high precision. In this configuration, the bonded portions 150 may be formed in the bus bar 140, the second metal member 1327, and the first metal member 1325. Thus, separation may not occur between the bus bar 140, the second metal member 1327, and the first metal member 1325.

As described above, resistance welding may provide strong bonding through the single bonded portion 150, and ultrasonic and laser welding may provide strong bonding through the plurality of bonded portions 150. With all of these techniques, after the welding process of the bus bar, the bus bar may not be easily separated from the secondary battery.

As described above, according to the present disclosure, to improve the weldability and durability of the upper cap component, groove portions may be formed through a pressing process, and then Ni plating may be applied, thereby preventing oxidation and enhancing weld strength. Further, bonding force between the first metal member and the second metal member may be enhanced, and good welding efficiency and productivity may be achieved. Still further, a single or a plurality of bonded regions may be formed through various welding methods (e.g., resistance, ultrasonic, or laser welding), thereby enhancing bonding strength and improving durability. Moreover, both oxidation prevention and improved weldability may be ensured by appropriately setting the flatness and the plating thickness.

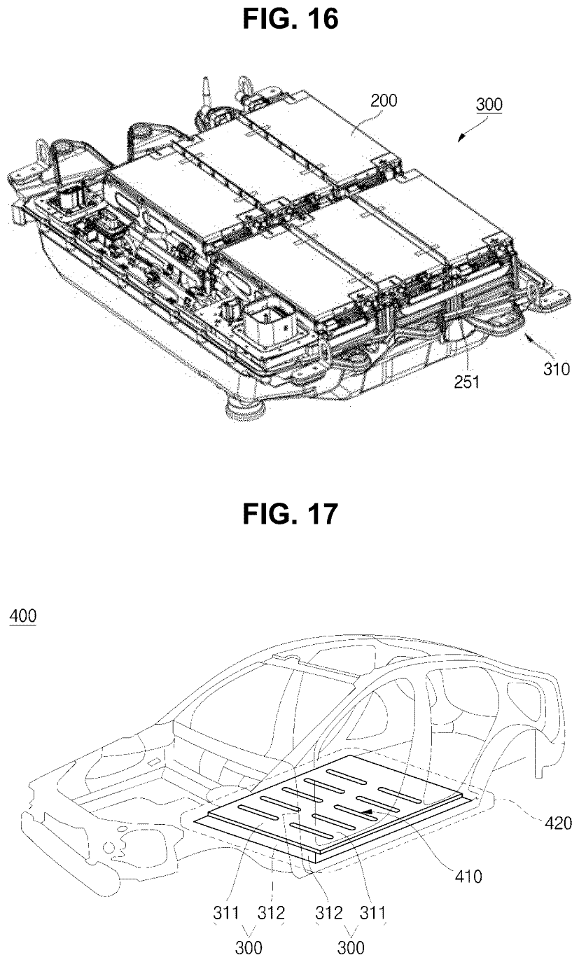

FIGS. 15 and 16 are perspective views showing a battery pack 300 including the exemplary cylindrical secondary battery according to the present disclosure. Referring to FIGS. 15 and 16, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In FIGS. 15 and 16, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

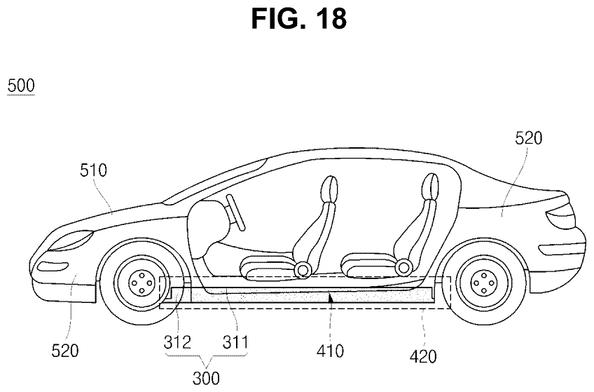

FIGS. 17 and 18 are perspective and side views showing vehicles 400 and 500 including the exemplary battery pack 300 according to the present disclosure. In FIG. 17, a battery pack 300 may include a battery pack cover 311 (may correspond to the first housing above), which is a part of a vehicle underbody 410, and a pack frame 312 (may correspond to the second housing above) disposed under the vehicle underbody 410. The pack frame 312 and the battery pack cover 311 may be integrally formed with a vehicle floor 420. The vehicle underbody 410 separates the inside and outside of a vehicle, and the pack frame 312 may be disposed outside the vehicle.

In FIG. 18, a vehicle 500 may be formed by combining additional parts, such as a hood 510 in front of the vehicle and fenders 520 respectively located in the front and rear of the vehicle to vehicle body parts 400. The vehicle 500 may further include a vehicle floor 420, which is one of the vehicle body parts 400 including the battery pack 300 including the pack frame 312 and the battery pack cover 311.

In the conventional laser etching process, removal of a plating layer may expose a metal substrate, potentially causing oxidation in a high-temperature and high-humidity environment. But in embodiments of the present disclosure, groove portions are formed through a pressing process without laser etching, and then a plating layer is formed. This process may prevent the metal substrate from being exposed to the atmosphere and may thereby prevent oxidation. As a result, the durability and safety of the secondary battery may be improved.

Further, in embodiments of the present disclosure, groove portions are formed by performing a pressing process on the surface of the cap assembly, and then a plating layer is formed. This process may lower the surface hardness of the cap assembly to a certain extent, thereby improving weldability. The surface softening effect may enhance bonding force essential for welding, thereby increasing the weld strength with the bus bar and enhancing the mechanical strength of the welded region.

In the conventional method, to address the oxidation issue caused by exposure of the metal substrate after laser etching, increasing the thickness of the plating layer and/or to applying additional anti-corrosion treatment have been used. In contrast, in the present disclosure, such unnecessary processes may be eliminated by applying plating after the pressing process. This process may also resolve plating thickness variation issues, thereby enhancing productivity. Further, because weldability is improved through surface processing, the overall efficiency of the production process may be improved. Moreover, in the conventional manufacturing process, additional anti-corrosion treatment or a separate process to address plating thickness variation are used after laser etching. In contrast, the present disclosure may resolve these issues through the pressing and plating processes, thereby reducing time and cost in subsequent processes.

However, aspects and features of the present disclosure are not limited to those described above, and other aspects and features not mentioned will be clearly understood by a person skilled in the art from the detailed description, described above.

Although the present disclosure has been described above with limited examples and drawings, the present disclosure is not limited thereto, and it is obvious that various modifications and variations may be made by those skilled in the art in the technical field to which the present disclosure belongs within the technical idea of the present disclosure.

What is claimed is:

1. A secondary battery comprising:
a case;
an electrode assembly accommodated in the case; and
a cap assembly sealing an opening in the case,
wherein the cap assembly comprises:
a first metal member comprising a plurality of first groove portions; and
a second metal member comprising a plurality of second groove portions, the second metal member being plated on the first metal member.

2. The secondary battery as claimed in claim 1, wherein the first metal member comprises iron, and the second metal member comprises nickel or nickel-phosphorus.

3. The secondary battery as claimed in claim 1, wherein the plurality of first groove portions and the plurality of second groove portions are formed to overlap each other in a thickness direction of the cap assembly.

4. The secondary battery as claimed in claim 1, wherein the first metal member comprises a first metal outer surface and a first metal inner surface opposite to the first metal outer surface, and the plurality of first groove portions is formed in the first metal outer surface.

5. The secondary battery as claimed in claim 1, wherein the second metal member comprises a second metal outer surface and a second metal inner surface opposite to the second metal outer surface, and the plurality of second groove portions is formed in the second metal outer surface.

6. The secondary battery as claimed in claim 1, wherein the first metal member comprises a first metal outer surface and a first metal inner surface opposite to the first metal outer surface, and the plurality of first groove portions is formed in the first metal outer surface,
wherein the second metal member comprises a second metal outer surface and a second metal inner surface opposite to the second metal outer surface and in contact with the first metal outer surface, and the plurality of second groove portions is formed in the second metal outer surface, and
wherein the plurality of second groove portions is provided above the plurality of first groove portions.

7. The secondary battery as claimed in claim 1, wherein the plurality of first groove portions and the plurality of second groove portions are at least one of straight lines, straight lines intersecting each other, circles, triangles, rectangles, pentagons, hexagons, or a matrix shape.

8. The secondary battery as claimed in claim 1, wherein each of of first groove portions and each of the second groove portions has a depth of 0.01 mm to 0.09 mm.

9. The secondary battery as claimed in claim 1, wherein each of the first groove portions and the second groove portions have a width of 0.01 mm to 0.3 mm.

10. The secondary battery as claimed in claim 1, wherein the plurality of first metal groove portions or the plurality of second metal groove portions has an area in a range from 5% to 100% of a total area of a surface of the cap assembly.

11. The secondary battery as claimed in claim 1, wherein the second metal member has a thickness of 3 μm to 7 μm.

12. The secondary battery as claimed in claim 1, wherein the cap assembly has a surface flatness of 0.004 mm to 0.005 mm.

13. The secondary battery as claimed in claim 1, wherein the cap assembly has an arithmetic average roughness (Ra) of 1.1 μm to 1.3 μm, an average maximum height (Rz) of 6 μm to 9 μm, and a maximum height (RzMax) of 6 μm to 9 μm.

14. The secondary battery as claimed in claim 1, wherein the cap assembly has a surface hardness of 250 HV to 310 HV.

15. The secondary battery as claimed in claim 1, further comprising a bus bar welded to the cap assembly,
wherein the bus bar has a weld tensile strength of 10 kgf to 21 kgf with respect to the cap assembly.

16. The secondary battery as claimed in claim 15, wherein a single bonded region is formed between the bus bar and the second metal member by resistance welding.

17. The secondary battery as claimed in claim 15, wherein a plurality of bonded regions is formed between the bus bar and the second metal member by ultrasonic welding.

18. The secondary battery as claimed in claim 15, wherein a portion of the bus bar, a portion of the second metal member, and a portion of the first metal member are melted and then cooled in a laser welding manner to form a plurality of bonded regions.

19. A method of manufacturing a cap assembly for a secondary battery, the method comprising:
providing a first metal member comprising a plurality of first groove portions through a pressing process; and
providing a second metal member on the first metal member by a plating process, the second metal member comprising a plurality of second groove portions overlapping the plurality of first metal groove portions.

20. The method as claimed in claim 19, wherein the first metal member comprises iron, and the second metal member comprises nickel or nickel-phosphorus.
